(19) United States
(12) Patent Application Publication
(10) Pub. No.: US 2015/0381364 A1
(43) Pub. Date: Dec. 31, 2015

(54) METHOD FOR SECURING SCALAR MULTIPLICATION AGAINST POWER ANALYSIS ATTACKS USING REFERENCE POINTS

(71) Applicant: UMM AL-QURA UNIVERSITY, MAKKAH (SA)

(72) Inventor: Turki F. Al-Somani, Makkah (SA)

(21) Appl. No.: 14/319,449

(22) Filed: Jun. 30, 2014

(51) Int. Cl. H04L 9/30; H04L 9/00

(52) U.S. Cl. CPC H04L 9/3066; H04L 9/003; H04L 2209/24

(57) ABSTRACT

A method for securing elliptic curve scalar multiplication against power analysis attacks includes the following steps: a) dividing secret key into number of partitions, b) computing reference points, c) associating key partitions with reference points, d) selecting a key partition randomly, e) processing the selected key partition from least to most until reaching the leftmost ‘1’, f) repeating the previous two steps until all key partitions have been processed, g) accumulating the resulting points of processing key partitions to produce the scalar multiplication product kP.

### FIELD OF THE INVENTION

This invention relates to a method for scalar multiplication and more particularly to a method for manipulating and modifying an elliptic curve cryptographic key to render the encryption resistant to power analysis attacks.

### BACKGROUND FOR THE INVENTION

Elliptic curve cryptography has recently been attracting increased interest. For example, standards for elliptic curve cryptography have been adapted by IEEE, ANSI, NIST, SEC and WTLS. The ability to use smaller key sizes and more computationally efficient elliptic curve cryptographic algorithms than those used in early public key cryptosystems are two reasons why elliptic curve cryptography is becoming more popular. In addition, elliptic curve cryptography is particularly suitable for implementations on smart cards and mobile devices.

A U.S. Patent of Mohammad Ibrahim U.S. Pat. No. 7,483,534 discloses a method for cryptographic encryptions and decryptions which use more than one quadratic variable that are termed y-coordinates to obtain an elliptic polynomial equation with multi y-coordinates instead of one y-coordinate. The additional y-coordinates are used to embed extra message data bits. Any-fold increase in the number of embedded message data bits in a single elliptic point can be achieved with the improved method. For example, any-fold increase in the number of embedded message data bits in a single elliptic point is achieved with the improved method. The reason is that the number of points that satisfy an elliptic polynomial equation defined over F(p) and which can be used in the corresponding cryptosystem is increased. The use of the additional y-coordinates can be used to reduce computational complexity or to increase security by making the bit positions where data bits are embedded known only to the sender and receiver. Also, it can be used as a countermeasure by randomizing the bit positions where data bits are embedded.

A more recent U.S. Pat. No. 8,422,685 of the present inventor and Alaaeldin Amin is entitled, “Method for Elliptic Curve Scalar Multiplication.” The patent discloses a method for elliptic curve scalar multiplication that provides several countermeasures to protect scalar multiplication of a private key by a point Pₖ to produce the product kP from power analysis attacks. First, the private key k, is partitioned into a plurality of key partitions which are processed in a random order, the resulting points being accumulated to produce the scalar product kP. Second, in each partition the encoding is randomly selected to occur in binary form or in Non-Adjacent form with the direction of bit inspection being randomly assigned between most-to-least and least-to-most. Third, in each partition each 0 in the key may randomly perform a dummy point addition operation in addition to the doubling operation. The method may be implemented in software, smart cards, circuits, processors, or application specific integrated circuits designed to carry out the method.

Notwithstanding the above, it is presently believed that there is a need and a potential commercial market for an improved method for scalar multiplication in accordance with the present invention. There should be a need and a potential commercial market for such methods in accordance with the present invention because they provide further protection against power analysis attacks. The method comprise and/or consists of the following steps: a) dividing secret key into number of partitions, b) computing reference points, c) associating key partitions with reference points, d) selecting a key partition randomly, e) processing the selected key partition from least to most until reaching the leftmost ‘1’, f) repeating the previous two steps until all key partitions have been processed, g) accumulating the resulting points of processing key partitions to produce the scalar multiplication product kP.

### SUMMARY OF THE INVENTION

In essence, the present invention contemplates a method for securing elliptic curve scalar multiplication against power analysis attacks. The method comprises and/or consists of the following steps and/or elements:

dividing secret key into number of partitions,

computing reference points,

associating key partitions with reference points,

selecting a key partition randomly,

processing the selected key partition from least to most until reaching the

leftmost “1”,

repeating the previous two steps until all key partitions have been

processed,

accumulating the resulting points of processing key partitions to produce

the scalar multiplication product kP.

The invention will now be described in connection with the accompanying drawings.

### DESCRIPTION OF THE DRAWINGS

FIG. 1 is a flowchart illustrating a method in accordance with a first embodiment of the invention.

### DETAILED DESCRIPTION OF THE PREFERRED EMBODIMENTS OF THE INVENTION

Scalar multiplication is the basic operation for ECCs. Scalar multiplication of a group of points on an elliptic curve is analogous to the exponentiation of a multiplicative group of integers modulo a fixed integer m. The scalar multiplication operation, denoted as kP, where k is an integer and P is a point on the elliptic curve, represents the addition of k copies of point P. Scalar multiplication is then computed by a series of point doubling and point addition operations of the point P that depends on the bit sequence that represents the scalar multiplier k. Several scalar multiplication methods have been proposed in the literature (Gordon, 1998). Computing kP can be done using a straightforward binary method, the double-and-add method, based on the binary expression of the multiplier k. Computing kP using the binary method is described as follows:

Let k=(kₘ₋₁, . . . , k₀), where kₘ₋₁ is the most significant bit of k, be the binary representation of k. The multiplier k can be written as:

$$k = {\sum }_{0 \leq i < m} {k}_{i} {2}^{i} = {k}_{m - 1} {2}^{m - 1} + {k}_{m - 2} {2}^{m - 2} + … + {k}_{1} 2 + {k}_{0} \qquad ( 1 )$$

The binary method algorithm is shown below:

| | |
|---|---|
| Inputs: | k, P. |
| Output: | kP. |

```
      1. Initialize Q[0] = O; Q[1] = P.
      2. for i = 0 to m − 1
        2.1. if (kᵢ = 1) then Q[0] = ADD(Q[0], Q[1])
        2.2. Q[1] = DBL(Q[1])
      3. end for
      4. return Q[0]
```

The binary scalar multiplication method is the most straightforward scalar multiplication method. It inspects the bits of the scalar multiplier k, if the inspected bit kᵢ=0, only point doubling is performed. If, however, the inspected bit kᵢ=1, both point doubling and point addition are performed. The binary method requires m point doublings and an average of m/2 point additions.

Power analysis attacks are usually divided into two types. The first type, Simple Power Analysis (SPA) attack, which is based on a single observation of power consumption, while the second type, Differential Power Analysis (DPA) attack combines SPA attack with an error-correcting technique using statistical analysis (Kocher, 1996), (Kocher, et. al. 1999). More importantly, classical DPA attacks have been extensively researched for each cryptosystem and new types of DPA attacks are continuously being developed. Many of the existing countermeasures are vulnerable to the more recent attacks including the Doubling Attack (Fouque and Valette, 2003), the Refined Power Analysis (RPA) (Goubin, 2003) and the Zero-Value Point Analysis (ZVP) (Akishita and Takagi, 2003).

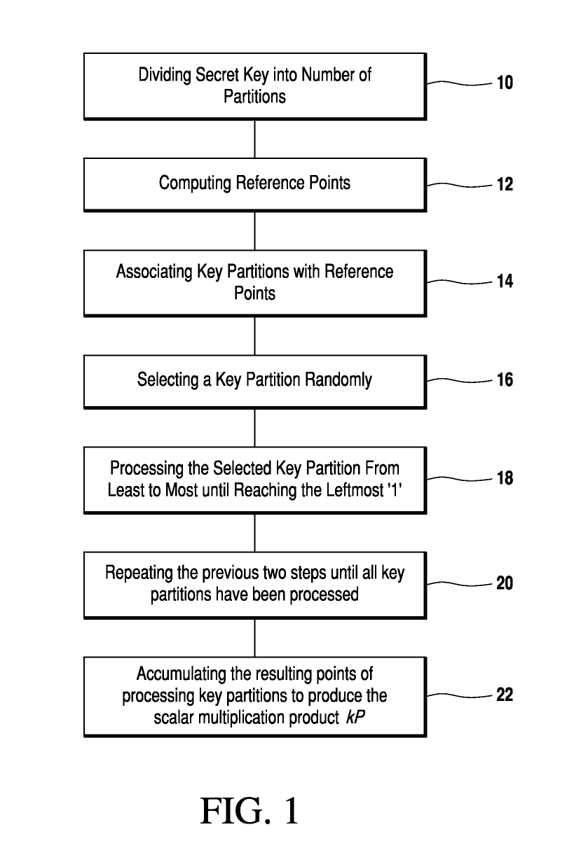

As illustrated in FIG. 1, a process for securing elliptic curve scalar multiplication against power analysis attacks includes the step 10 of dividing secret key into number of partitions. The next step 12 calls for computing reference points, which are computed using a sequence of doubling operations of the base point P. The next step 14 involves associating key partitions with reference points. The aforementioned steps are followed by step 16 which includes selecting a key partition randomly. The next step 18 calls for processing the selected key partition from least to most until reaching the leftmost “1”. The following step 20 calls for repeating the previous two steps until all key partitions have been processed. A final step 22 calls for accumulating the resulting points of processing key partitions to produce the scalar multiplication product kP.

DPA attacks use error correction techniques and statistical analysis to extract small differences in the power consumption signals. Several countermeasures have been proposed to provide security against DPA attacks (Coron, 1999; Ha and Moon, 2002; Okeya and Sakurai 2000; Liardet and Smart, 2001; Joye and Quisquater, 2001; Joye and Tymen, 2001; Mamiya et. al., 2004; Zhang, 2007; Ciet and Joye, 2003). These countermeasures include algorithms based on: randomizing the private exponent (Coron, 1999), blinding the base point P (Coron, 1999; Ha and Moon, 2002; Mamiya et. al., 2004; Zhang, 2007; Ciet and Joye, 2003), randomizing the projective coordinates (Coron, 1999), using a random isomorphism of an elliptic curve (Joye and Tymen, 2001) and using special forms of certain elliptic curves (the Montgomery form (Okeya and Sakurai 2000), the Jacobian form (Liardet and Smart, 2001) and the Hessian form (Joye and Quisquater, 2001)). All of these countermeasures, however, add computational overhead and are still vulnerable to the more recent DPA attacks, e.g. the Doubling attack (Fouque and Valette, 2003), the Refined Power Analysis (RPA) (Goubin, 2003) and the Zero-Value Point (ZVP) attack (Akishita and Takagi, 2003). Resistance against these recent DPA attacks can be achieved by combining two or more of the countermeasures proposed in the literature thus far. This patent presents an efficient countermeasure against DPA attacks which requires no additional computation overhead.

The proposed method partitions the secret key into a number of partitions that can be processed by the processor independently. The points resulting from processing these key partitions are accumulated to produce the scalar product kP. Each key partition is associated with a precomputed point to keep its significance. The precomputed points are computed off-line and stored in the memory to be reused as needed. The precomputed points are used as reference points. Scalar multiplication starts by processing key partitions from least to most randomly. A key observation is that the number of doublings could be reduced since we need to perform doublings till we reach the leftmost “1” in a key partition. This means that we don't have to perform doublings after we reach this bit since we could jump directly to the next partition with its associated reference point. For example, if we have the following key partition: “0010”, we only need to perform two doublings since we are inspecting the key partition from least to most. Key partitioning, on the other hand, is performed as following:

The key is divided into u partitions as:

k=k^{(u-1)}∥k^{(u-2)}∥ . . . ∥k⁽¹⁾∥k⁽⁰⁾

To compute the scalar product kP, these partitions are associated with a set of reference points to keep the significance of each key partition, thus these partitions can be processed independently either sequentially or in parallel.

$$\begin{matrix}kP = ( {k}^{( u - 1 )} ‖ {k}^{( u - 2 )} ‖ … ‖ {k}^{( 1 ) ‖} {k}^{( 0 )} ) \cdot P \\ = ( {2}^{size ( u - 1 )} \cdot {k}^{( u - 1 )} + {2}^{size ( u - 2 )} \cdot {k}^{( u - 2 )} + … + {2}^{size ( 1 )} \cdot {k}^{( 1 )} + {k}^{( 0 )} ) \cdot P \\ = ( {2}^{size ( u - 1 )} P ) \cdot {k}^{( u - 1 )} + ( {2}^{size ( u - 2 )} P ) \cdot {k}^{( u - 2 )} + … + \\ ( {2}^{size ( 1 )} P ) \cdot {k}^{( 1 )} + ( P ) {k}^{( 0 )} \\ = {P}_{u - 1} \cdot {k}^{( u - 1 )} + {P}_{u - 2} \cdot {k}^{( u - 2 )} + … + {P}_{1} \cdot {k}^{( 1 )} + {P}_{0} {k}^{( 0 )} \\ = {P}_{u - 1} \cdot {k}^{( u - 1 )} + {P}_{u - 2} \cdot {k}^{( u - 2 )} + … + {P}_{1} \cdot {k}^{( 1 )} + {Pk}^{( 0 )}\end{matrix}$$

where Pᵢ (i=1, 2, . . . , u−1) is the reference point associated with key partition k⁽ⁱ⁾ and size(j)=Σᵢ₌₀^{j-1} size of k⁽ⁱ⁾. Thus, each partition k⁽ⁱ⁾ is associated with a reference point Pᵢ forming the pair:

(k⁽ⁱ⁾,Pᵢ),where P₀=P.

The key partition sizes may be equal or different. For equal sizes, the key partition size is equal to

$$⌈ \frac{m}{u} ⌉$$

for u key partitions. Reference points are computed using a sequence of doubling operations of the base point P. For u key partitions, the required number of reference points is (u−1). The resulting points of processing these key partitions are assimilated at the end to produce the scalar multiplication product kP=Σᵢ₌₀^{u-1}k⁽ⁱ⁾Pᵢ where P₀=P. The pseudo-code of the proposed scalar multiplication method is given in Algorithm 2.

| | |
|---|---|
| Inputs: | k, P. |
| Output: | kP. |

```
      Key Partitioning: k = k^{(u-1)}||k^{(u-2)}||...||k⁽¹⁾||k⁽⁰⁾, for u key partitions.
      Initialization: Q[0] = O; Q[1] = P.
      Precomputation of Reference Points and Storing them in the
      Memory:
            1. P₀ = Q[0].
            2. for i = 1 to u − 1 do
            2.1. for j = 0 to k⁽ⁱ⁻¹⁾ size − 1 do
                  2.1.1 Q[0] = 2Q[0]
            2.2. end for
            2.3. Pᵢ = Q[0]
      3. end for
Key Partitions Association with Reference Points:
      4. for i = 0 to u − 1 do (k⁽ⁱ⁾, Pᵢ).
Scalar Multiplication (kP):
      Initialization: Q[0] = O.
      5. while (key partitions are not all processed)
            i = Random (key partition number that has not been
      processed yet by the processor)
            Initialization: Q[1] = Pᵢ, j = 0.
            5.1 while (The leftmost “1” in the key partition k⁽ⁱ⁾ is
            not reached)
                  5.1.1  if (kⱼ⁽ⁱ⁾ = 1) then Q[0] = ADD(Q[0], Q[1])
                  5.1.2  Q[1] = DBL(Q[1])
                  5.1.3  j = j + 1
            5.2 end while
      6. end while
      7. return Q[0]
```

In the best case, the proposed method requires

$$⌈ \frac{m}{u} ⌉$$

point doublings. On the other hand, the worst case requires m point doublings, which happens if all key partitions have “1” in their leftmost bit. Accordingly, the proposed method requires

$$( ⌈ \frac{m}{u} ⌉ \leq point doublings \leq m )$$

and an average of m/2 point additions. This performance improves to

$$( ⌈ \frac{m}{u} ⌉ \leq point doublings \leq m )$$

point doublings and an average of m/3 point additions when NAF encoding is used (Joye and Tymen, 2001).

The security of the proposed method depends on the confusion level that could be reached by using the number of key partitions and randomization. A moderate key partition number should be log₂(m) to reach a confusion level that secures scalar multiplication against power analysis attacks. An attacker of such scalar multiplication method will be totally confused with leaked information in such randomized environment. The adopted resistance measures depend on confusing not only the scalar multiplication's intermediate values, but also the key bit positions. Thus, even if leaked information can identify the type of performed operation, e.g. point doubling or point addition, attackers can neither be sure of the corresponding key bit value nor its position.

### REFERENCES

1. Akishita, T. and Takagi, T. 2003: ‘Zero-value point attacks on elliptic curve cryptosystem’. In Information Security Conference—ISC′03, LNCS 2851, Springer-Verlag, pp. 218-233.
2. Avanzi, R. M., Cohen, H., Doche, C., Frey, G., Lange, T., Nguyen, K., and Vercauteren, F., 2005, Handbook of Elliptic and Hyperelliptic Curve Cryptography, CRC Press.
3. Chevallier-Mames, B., Ciet, M. and Joye, M. 2004: ‘Low-Cost Solutions for Preventing Simple Side-Channel Analysis: Side-Channel Atomicity’. IEEE Trans. Computers, Vol. 53, No. 6, pp. 760-768.
4. Ciet, M. and Joye, M. 2003: (Virtually) Free randomization technique for elliptic curve cryptography, in: Proc. of ICICS-2003, LNCS, vol. 2836, Springer-Verlag, Berlin, pp. 348-359.
5. Cohen, H., Ono, T. and Miyaji, A. 1998: ‘Efficient Elliptic Curve Exponentiation Using Mixed Coordinates’. In Advances in Cryptology—SIACRYPT '98, K. Ohta nd D. Pei, Eds., vol. 1514 of Lecture Notes in Computer Science, pp. 51-65.
6. Coron, J. 1999: ‘Resistance against differential power analysis for elliptic curve cryptosystems’. In Cryptographic Hardware and Embedded Systems—CHES′99, LNCS 1717, Springer-Verlag, pp. 292-302.
7. ElGamal, T. 1985: ‘A Public-Key Cryptosystem and a Signature Scheme Based on Discrete Logarithms’. Advances in Cryptology: Proceedings of CRYPTO 84, Springer Verlag, pp. 10-18.
8. Fouque, P. and Valette, F. 2003: ‘The doubling attack—why upwards is better than downwards’. In Cryptographic Hardware and Embedded Systems—CHES′03, LNCS 2779, Springer-Verlag, pp. 269-280.
9. Gordon, D.: ‘A Survey of Fast Exponentiation Methods’. Journal of Algorithms, 1998, pp. 129-146.
10. Goubin, L. 2003: ‘A refined power-analysis attack on elliptic curve cryptosystems’. In Public Key Cryptography—PKC′03, LNCS 2567, Springer-Verlag, pp. 199-210.
11. Ha, J. and Moon, S. 2002: ‘Randomized signed-scalar multiplication of ECC to resist power attacks’. In Cryptographic Hardware and Embedded Systems—CHES '02, LNCS 2523, Springer-Verlag, pp. 551-563.
12. Joye, M. and Quisquater, J. 2001: ‘Hessian elliptic curves and side-channel attacks’. In Cryptographic Hardware and Embedded Systems—CHES '01, LNCS 2162, Springer-Verlag, pp. 402-410.
13. Joye, M. and Tymen, C. 2001: ‘Protections against differential analysis for elliptic curve cryptography’. In Cryptographic Hardware and Embedded Systems—CHES '01, LNCS 2162, Springer-Verlag, pp. 377-390.
14. Joye, M. and Tymen, C. 2001: ‘Compact Encoding of Non-Adjacent Forms with Applications to Elliptic Curve Cryptography’. Public Key Cryptography 2001, LNCS 1992, Springer-Verlag, pp. 353-364.
15. Koblitz, N. 1987: ‘Elliptic curve cryptosystems’. Mathematics of Computation, vol. 48, pp. 203-209.
16. Kocher, C. 1996: ‘Timing Attacks on Implementations of Diffe-Hellman, RSA, DSS, and Other Systems’. CRYPTO '96, LNCS 1109, pp. 104-113.
17. Kocher, C., Jaffe, J. and Jun, B. 1999: ‘Differential power analysis’. CRYPTO '99, LNCS 1666, pp. 388-397.
18. Liardet, P. and Smart, N. 2001: ‘Preventing SPA/DPA in ECC systems using the Jacobi form’. In Cryptographic Hardware and Embedded Systems—CHES '01, LNCS 2162, Springer-Verlag, pp. 391-401.
19. Lidl, R. and Niederreiter, H. 1994: ‘Introduction to finite fields and their applications’. Cambridge University Press, Cambridge, UK, revised edition.
20. Mamiya, H., Miyaji, A. and Morimoto, H. 2004: ‘Efficient countermeasure against RPA, DPA, and SPA’. In Cryptographic Hardware and Embedded Systems—CHES '04, LNCS 3156, Springer-Verlag, pp. 343-356.
21. McEliece, R. 1987: ‘Finite Fields for Computer Scientists and Engineers’. Kluwer Academic Publishers.
22. Okeya, K. and Sakurai, K. 2000: ‘Power analysis breaks elliptic curve cryptosystems even secure against the timing attack’. In Advances in Cryptology—INDOCRYPT′00, LNCS 1977, Springer-Verlag, pp. 178-190.
23. Rivest, R., Shamir, A. and L. Adleman. 1978: ‘A method for obtaining digital signatures and public key cryptosystems’. Communications of the ACM, Vol. 21, No. 2, pp. 120-126.
24. Smart, N. 2003: ‘An analysis Goubin's refined power analysis attack’. Proc. of Cryptographic Hardware and Embedded Systems—CHES '03, LNCS 2779, Springer-Verlag, pp. 281-290.
25. Zhang, N., Chen, Z. and Xiao, G. 2007: ‘Efficient Elliptic Curve Scalar Multiplication Algorithms Resistant to Power Analysis’. Information Sciences, 177, pp. 2119-2129.

While the invention has been described in connection with its preferred embodiments, it should be recognized that changes and modifications may be made therein without departing from the scope of the appended claims.

What is claimed is:

1. A method for securing elliptic curve scalar multiplication against power analysis attacks in an electronic communication system, said method comprising:
a) dividing secret key into number of partitions,
b) computing reference points,
c) associating key partitions with reference points,
d) selecting a key partition randomly,
e) processing the selected key partition from least to most until reaching the leftmost “1”,
f) repeating the previous two steps until all key partitions have been processed,
g) accumulating the resulting points of processing key partitions to produce the scalar multiplication product kP.

2. The method for securing elliptic curve scalar multiplication against power analysis attacks according to claim 1, in which said secret key is divided into u partitions as follows:
k=k^{(u-1)}∥k^{(u-2)}∥ . . . ∥k⁽¹⁾∥k⁽⁰⁾
wherein each partition is processed independently either sequentially or in parallel.

3. The method for securing elliptic curve scalar multiplication against power analysis attacks according to claim 2, in which reference points are computed using a sequence of doubling operations of the base point P.

4. The method for securing elliptic curve scalar multiplication against power analysis attacks according to claim 3, in which each partition is associated with a reference point forming the pair: (k⁽ⁱ⁾, Pᵢ), where P₀=P.

5. The method for securing elliptic curve scalar multiplication against power analysis attacks according to claim 4, wherein the partitions are processed independently as follows:
$$\begin{matrix}kP = ( {k}^{( u - 1 )} ‖ {k}^{( u - 2 )} ‖ … ‖ {k}^{( 1 ) ‖} {k}^{( 0 )} ) \cdot P \\ = ( {2}^{size ( u - 1 )} \cdot {k}^{( u - 1 )} + {2}^{size ( u - 2 )} \cdot {k}^{( u - 2 )} + … + {2}^{size ( 1 )} \cdot {k}^{( 1 )} + {k}^{( 0 )} ) \cdot P \\ = ( {2}^{size ( u - 1 )} P ) \cdot {k}^{( u - 1 )} + ( {2}^{size ( u - 2 )} P ) \cdot {k}^{( u - 2 )} + … + \\ ( {2}^{size ( 1 )} P ) \cdot {k}^{( 1 )} + ( P ) {k}^{( 0 )} \\ = {P}_{u - 1} \cdot {k}^{( u - 1 )} + {P}_{u - 2} \cdot {k}^{( u - 2 )} + … + {P}_{1} \cdot {k}^{( 1 )} + {P}_{0} {k}^{( 0 )} \\ = {P}_{u - 1} \cdot {k}^{( u - 1 )} + {P}_{u - 2} \cdot {k}^{( u - 2 )} + … + {P}_{1} \cdot {k}^{( 1 )} + {Pk}^{( 0 )}\end{matrix}$$
where Pᵢ (i=1, 2, . . . , u−1) is the reference point associated with key partition k⁽ⁱ⁾ and size(j)=Σᵢ₌₀^{j-1} size of k⁽ⁱ⁾.

6. The method for securing elliptic curve scalar multiplication against power analysis attacks according to claim 5, wherein the key partition sizes may be equal or different. For equal sizes, the key partition size is equal to
$$⌈ \frac{m}{u} ⌉$$
for u key partitions.

7. The method for securing elliptic curve scalar multiplication against power analysis attacks in according to claim 6, wherein the required number of reference points is (u−1) and wherein the resulting points of processing the key partitions are assembled at the end of processing to produce the scalar multiplication product kP=Σᵢ₌₀^{u-1}k⁽ⁱ⁾Pᵢ where P₀=P.

8. The method for securing elliptic curve scalar multiplication against power analysis attacks according to claim 7, in which a pseudo-code of the proposed scalar multiplication is calculated as follows:

| | |
|---|---|
| Inputs: | k, P. |
| Output: | kP. |

```
      Key Partitioning: k = k^{(u-1)}||k^{(u-2)}||...||k⁽¹⁾||k⁽⁰⁾, for u key partitions.
Initialization: Q[0] = O; Q[1] = P.
Precomputation of Reference Points and Storing them in the Memory:
      1. P₀ = Q[0].
      2. for i = 1 to u − 1 do
            2.1. for j = 0 to k⁽ⁱ⁻¹⁾ size − 1 do
                  2.1.1 Q[0] = 2Q[0]
            2.2. end for
            2.3. Pᵢ = Q[0]
      3. end for
Key Partitions Association with Reference Points:
      4. for i = 0 to u − 1 do (k⁽ⁱ⁾, Pᵢ).
Scalar Multiplication (kP):
      Initialization: Q[0] = O.
      5. while (key partitions are not all processed)
            i = Random (key partition number that has not been
      processed yet by the processor)
            Initialization: Q[1] = Pᵢ, j = 0.
            5.1 while (The leftmost “1” in the key partition k⁽ⁱ⁾ is not
      reached)
                  5.1.1 if (kⱼ⁽ⁱ⁾ = 1) then Q[0] = ADD(Q[0], Q[1])
                  5.1.2 Q[1] = DBL(Q[1])
                  5.1.3 j = j + 1
            5.2 end while
      6. end while
      7. return Q[0]
```
